(19) United States
(12) Patent Application Publication
(10) Pub. No.: US 2017/0028803 A1
(43) Pub. Date: Feb. 2, 2017

(54) VEHICLE CHASSIS AND SUSPENSION SYSTEM

(71) Applicant: SWSRMR PTY LTD., Queensland (AU)

(72) Inventor: Ronald Edward SCHLIEBS, Tasmania (AU)

(21) Appl. No.: 15/106,596

(22) PCT Filed: Dec. 18, 2014
(86) PCT No.: PCT/AU2014/050430

§ 371 Date: Jun. 20, 2016

(30) Foreign Application Priority Data
Dec. 20, 2013 (AU) 2013904991

(51) Int. Cl. B60G 9/02; B60G 5/00

(52) U.S. Cl. CPC B60G 9/025; B60G 5/00; B60G 2200/314; B60G 2200/422; B60G 2300/0262

(57) ABSTRACT

A haulage vehicle has a suspension system providing a flexible connection between a vehicle chassis and at least one axle housing. The system has three longitudinal link members, a transverse link member, and a resilient member adjacent each end of the axle housing; all of which are connected at one end to the vehicle chassis and at an opposite end to the axle housing. The transverse link member substantially prevents movement of the axle housing in a transverse direction, and the three longitudinal link members are substantially aligned with the longitudinal axis of the chassis and spaced apart, providing a three-point connection between the chassis and axle housing. The three-point connection keeps the axle housing in a substantially transverse orientation relative to the chassis, preventing rotation of the axle housing about the longitudinal axis of the axle housing while allowing movement of the axle housing in the vertical plane.

### FIELD OF THE INVENTION

This invention relates to a vehicle chassis and suspension system, and in particular, but not exclusively to a vehicle chassis and suspension system for a heavy haulage vehicle.

### BACKGROUND

The mining industry in particular uses a range of haulage vehicles for transporting large quantities of material over relatively short distances. The loads are generally carried over tracks or roads that are of a temporary nature, and therefore the vehicles must be able to cope with the rough road conditions while carrying significant loads. The usage of haulage vehicles that can carry loads of fifty to ninety tonnes is relatively common nowadays, and specialised vehicles that can carry up to three hundred tonnes are also used in some applications.

While it is possible to produce vehicles that can carry such loads, and which can cope with the rough roading conditions, the cost of producing and maintaining such vehicles can be one of the major costs of a mining operation. Modern articulated vehicles for example can cope with the difficult roading surfaces and with travel over open terrain and various inclines, due to their sophisticated steering, drive and traction systems. But their limited load carrying capabilities, their initial cost, and high maintenance costs, can have a negative effect on the profitability of a mining operation.

The simpler ‘off-highway dump trucks’ provide a lower cost alternative to the articulated vehicles. However these vehicles are generally only cost effective over short distances and they require roading of a particular standard.

The ‘Extra Heavy Combination Vehicles’ are suited to longer hauls over roads of good quality, but their lighter construction often means that they do not cope well with the rigours of mining conditions, and maintenance contributes to higher overall operating costs.

The overall weight and height of these haulage vehicles is also a factor. Excessive componentry and structure can reduce the payload, and excessive height can mean a high centre of gravity and therefore lower stability on slopes and undulating surfaces, and when turning.

There is an increasing need for a haulage vehicle which is relatively simple and robust, but which can cope with a range of roading conditions from rough mining tracks to open highways, and which can travel at useful speeds when the conditions allow, while still carrying a high payload. The suspension system of such a vehicle is a key to allowing the flexibility of use while still keeping cost of ownership and maintenance within acceptable levels.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a vehicle chassis and/or suspension system which will at least go some way towards overcoming one or more of the above mentioned problems, or at least provide the public with a useful choice.

### STATEMENTS OF THE INVENTION

Accordingly, in a first aspect, the invention may broadly be said to consist in a vehicle suspension system for providing a flexible connection between a vehicle chassis and at least one axle housing, the vehicle suspension system having three longitudinal link members, at least one transverse link member, and at least one resilient member situated adjacent each end of the axle housing; all of which are connected at one end to the vehicle chassis and at an opposite end to the axle housing, wherein the at least one transverse link member is configured to substantially prevent movement of the axle housing in a transverse direction, and the three longitudinal link members are each substantially aligned with the longitudinal axis of the chassis and am spaced apart to provide a three point connection between the chassis and the axle housing which is configured to keep the axle housing in a substantially transverse orientation relative to the chassis and to prevent rotation of the axle housing about the longitudinal axis of the axle housing while allowing movement of the axle housing in the vertical plane, and wherein movement of the axle housing in the vertical plane is limited by the resilient members which connect each end of the axle to the chassis.

Preferably the vehicle suspension system includes two resilient members at each end of the or each axle housing.

Preferably each of the two resilient members at each end of the or each axle housing is positioned on an opposite side of the axle housing to the other.

Preferably the connection of the resilient members to the or each axle housing is situated near or adjacent the lowest point of the or each axle housing in the vicinity of the connection.

Preferably a first of the three longitudinal links is connected to a left half of the axle housing, and a second of the three longitudinal links is connected to a right half of the axle housing.

Preferably a third of the three longitudinal links is connected to a mid section of the axle.

Preferably the first and the second longitudinal links are connected to points low on the axle housing and the third longitudinal link is connected to a point high on the axle housing.

Preferably each of the longitudinal links is substantially parallel to the others.

Preferably the first and the second longitudinal links are each connected to fixed struts which extend downwards from the main longitudinal chassis members.

Preferably the longitudinal and transverse links are connected to both the chassis and to the axle housing using pinned joints.

Preferably the resilient members include springs.

Optionally the resilient members include air springs.

Preferably the resilient members include shock absorbers.

In a second aspect, the invention may broadly be said to consist in a vehicle suspension system for providing a flexible connection between a vehicle chassis and a forward axle, the chassis comprising two longitudinal beams, each longitudinal beam being stopped upwards as it passes over the axle, and the connection between the vehicle chassis and the axle comprising two longitudinal link members, two angled link members and two resilient members configured to allow movement of the axle in a substantially vertical direction only, the angled link members being oriented in a direction that is between a longitudinal direction and a transverse direction.

Preferably the angled link members are oriented in a direction that is between thirty and sixty degrees offset from the longitudinal direction.

Preferably the longitudinal link members are connected to a lower portion of the stepped longitudinal beams of the chassis.

Preferably the resilient members are connected to an upper portion of the stepped longitudinal beams of the chassis.

Preferably the longitudinal link members are connected to a lower portion of the axle.

Preferably the angled link members are connected to an upper portion of the axle.

Preferably the angled link members are connected to the axle at a location at or adjacent a centre section of the axle.

Preferably the longitudinal link members are connected to the axle at locations at or adjacent each end of the axle.

Preferably the connection between the longitudinal link members and the longitudinal beams of the chassis is aligned with a lower flange of the longitudinal beams.

Preferably the connection between the angled link members and the longitudinal beams of the chassis is aligned with an upper flange of the longitudinal beams.

In a third aspect, the invention may broadly be said to consist in a vehicle incorporating at least one vehicle suspension system substantially as specified herein.

Preferably the vehicle includes two rear axles and each rear axle is connected to the chassis of the vehicle by a vehicle suspension system substantially as specified herein.

Preferably the longitudinal links of the forward-most rear axle are connected to the rear face of the forward-most rear axle, and the longitudinal links of the aft-most rear axle are connected to the forward face of the aft-most rear axle.

Preferably the first longitudinal link of the forward-most rear axle and the first longitudinal link of the aft-most rear axle are each connected to a first fixed strut that extends downwards from a chassis of the vehicle, and the second longitudinal link of the forward-most rear axle and the second longitudinal link of the aft-most rear axle are each connected to a second fixed strut that extends downwards from the chassis.

Preferably the first and the second fixed struts are triangular in shape in side elevation view, having a base of the triangular shape attached to the chassis member and having the longitudinal links attached at or adjacent a free apex of the triangular shape.

Preferably the vehicle is a haulage vehicle.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

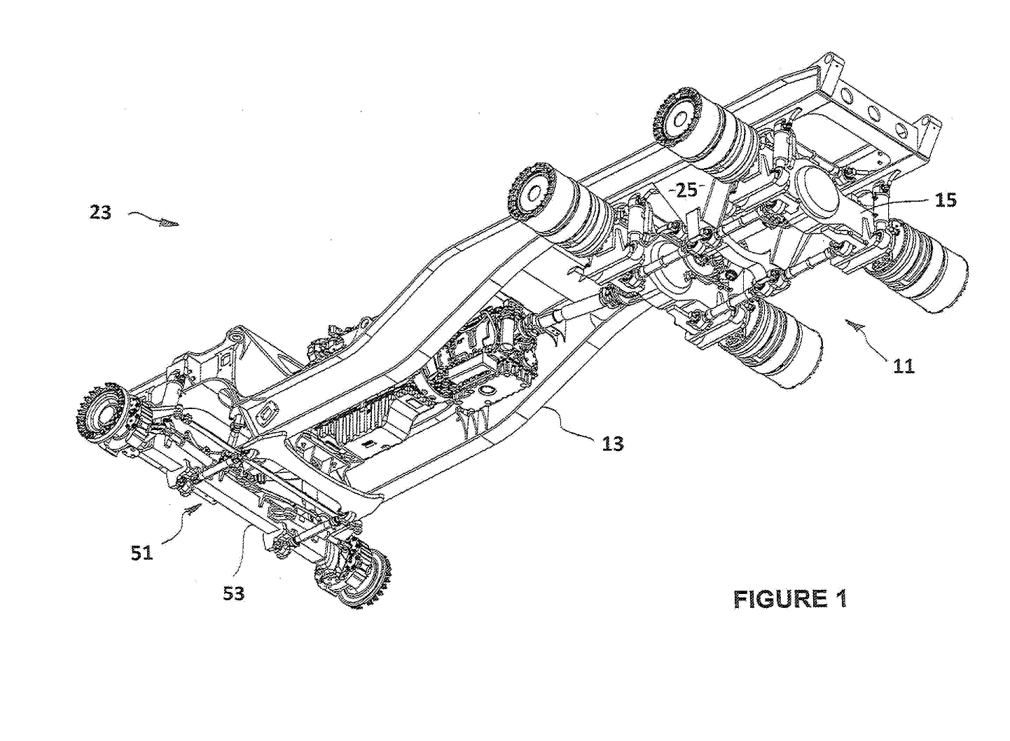

FIG. 1 is a perspective view showing an underside of a vehicle suspension system and chassis according to the present invention,

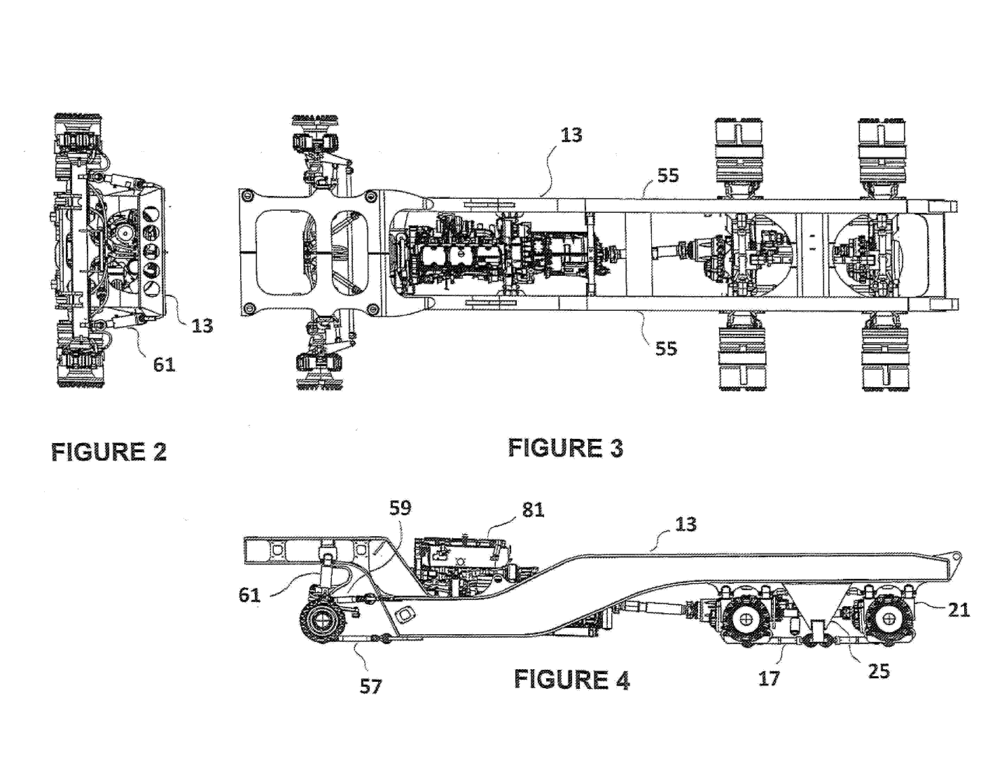

FIG. 2 is an end elevation view of the vehicle suspension system,

FIG. 3 is a plan elevation view of the vehicle suspension system,

FIG. 4 is a side elevation view of the vehicle suspension system and chassis,

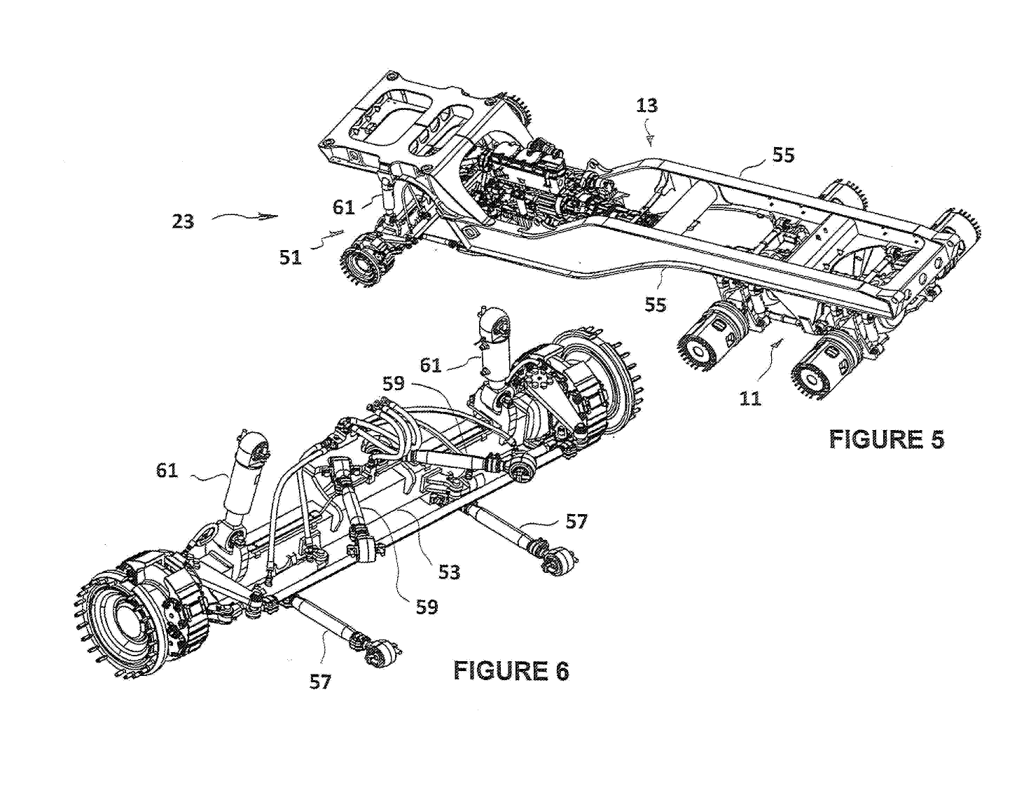

FIG. 5 is a perspective view showing an upper view of the vehicle suspension system and chassis,

FIG. 6 is an upper perspective view of the main components of a forward suspension system,

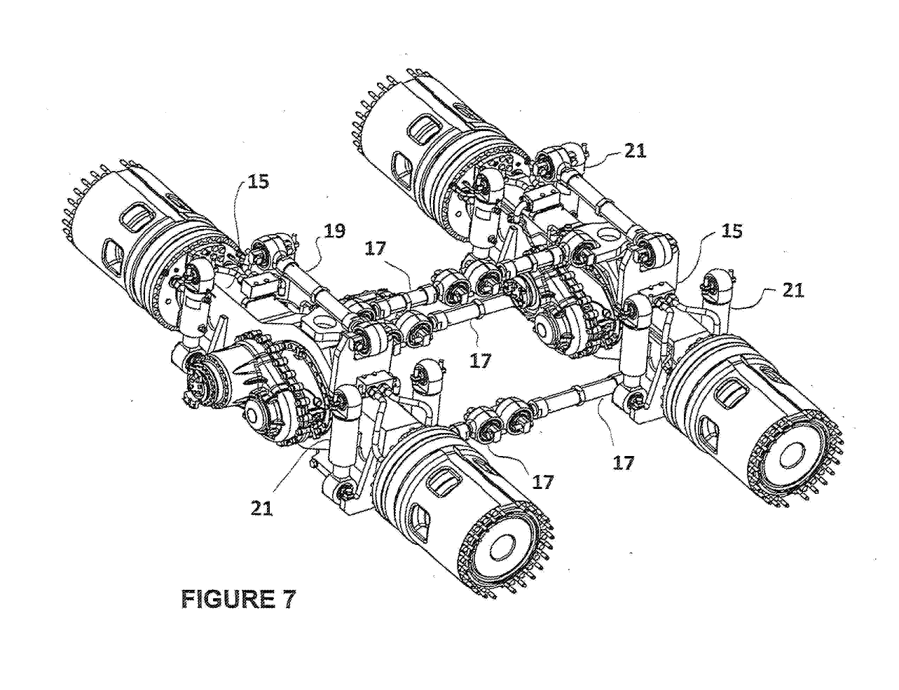

FIG. 7 is an upper perspective view of the main components of a rear suspension system,

FIG. 8 is a perspective view showing connection points on a forward end of the chassis, and

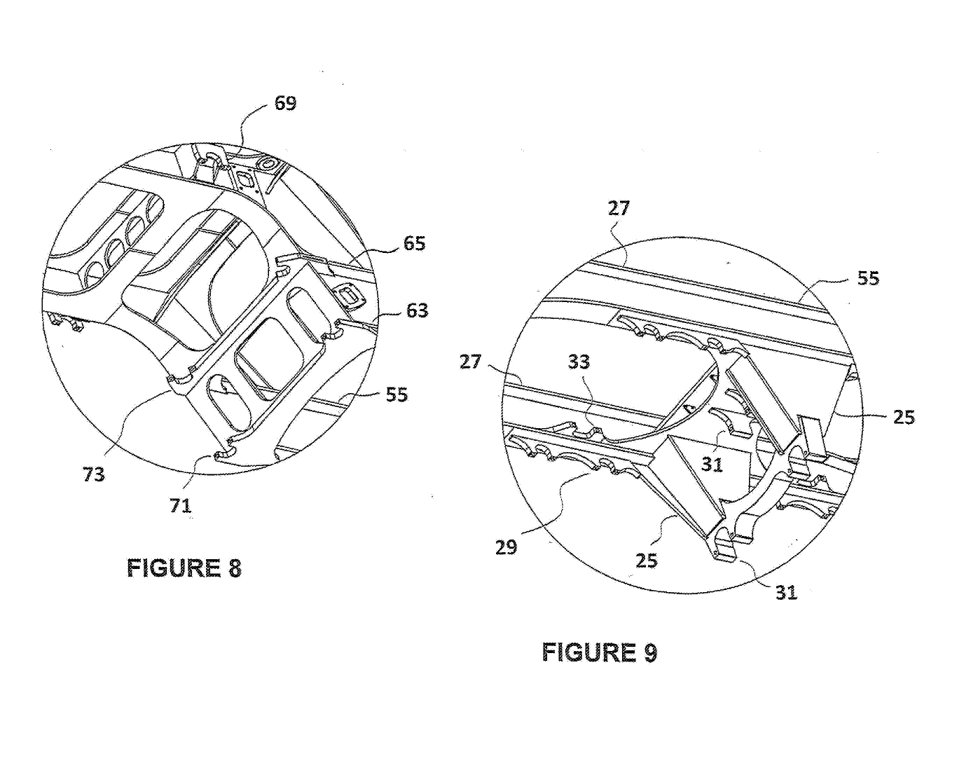

FIG. 9 is a perspective view showing connection points on an aft end of the chassis.

With reference to FIGS. 1 to 5, 7 and 9, a vehicle suspension system (11) according to the present invention will now be described. The vehicle suspension system (11) is designed for use on the rear axles of heavy haulage vehicles, and is designed to be rugged and durable for use on both unpaved and paved surfaces, while being relatively compact and low in weight.

The vehicle suspension system (11) provides a flexible connection between a vehicle chassis (13) and at least one rear axle housing (15). The vehicle suspension system (11) includes three longitudinal link members (17) and at least one transverse link member (19). The link members are each connected at one end to the vehicle chassis (13) and at an opposite end to the axle housing (15).

The vehicle suspension system (11) also includes two resilient members (21) situated adjacent each end of the axle housing (15). The resilient members (21) are in the form of telescopic shock absorbers which are connected at one end to the vehicle chassis (13) and at an opposite end to the axle housing (15).

The transverse link member (19) is configured to substantially prevent movement of the axle housing (15) in a transverse direction.

The three longitudinal link members (17) are each substantially aligned with the longitudinal axis of the chassis (13) and are spaced apart to provide a three point connection between the chassis (13) and the axle housing (15). This configuration of the three longitudinal link members (17) is configured to keep the axle housing (15) in a substantially transverse orientation relative to the chassis (13) and to prevent rotation of the axle housing (15) about its longitudinal axis. However, the configuration of the three longitudinal link members (17) still allows movement of the axle housing (15) in the vertical plane.

Movement of each end of the axle housing (15) in the vertical plane is limited by the resilient members (21) which connect each end of the axle (15) to the chassis (13). The resilient members (21) include shock absorbers and springs to support the weight of the loaded vehicle (23).

In this example, the vehicle (23) includes two rear axles (15), and each axle (15) has two resilient members (21) at each end. And at each end, one resilient member (21) is connected to axle housing (15) and the other resilient member (21) is connected to the other side of the axle housing (15). The connection of the resilient members (21) to the axle housings (15) is situated near or adjacent the lowest point of the axle housings (15) in the vicinity of the connection. Due to this configuration, the length of the resilient members (21) can be maximised, and the reaction loads experienced by the axle housing (15) from the resilient members (21) are balanced, minimising any twisting action caused by the resilient members (21) when bumps are encountered while travelling over rough terrain.

A first of the three longitudinal links (17) is connected to a left half of the axle housing (15), and a second of the three longitudinal links (17) is connected to a right half of the axle housing (15), both at points low on the axle housing (15). And a third of the three longitudinal links (17) is connected to a mid section of the axle (15), at a point high on the axle housing (15). All of the longitudinal links (17) are substantially parallel to the others. In this way the longitudinal links (17) provide a three point triangular linkage system between the axle housing (15) and the chassis (13), allowing vertical movement of the axle housing (15), while restricting rotation of the axle housing (15) about its own axis and about a vertical axis.

The first and the second longitudinal links (17) are each connected to the bottom end of fixed struts (25) which extend in a downwards direction from the main longitudinal chassis members (27). The fixed struts (25) are triangular in shape, with a base of the triangular shape connected to the main longitudinal chassis members (27) and with a connection to the longitudinal links (17) at the free apex of the triangular shape.

Each of the longitudinal and transverse links (17) and (19) are connected to both the chassis (13) and to the axle housing (15) using pinned joints which allow for limited pivoting movement.

FIG. 9 shows resilient member attachment lugs (29), longitudinal member attachment lugs (31) and a transverse member attachment lug (33), on an aft end of the chassis (13).

With reference to FIGS. 1 to 6, and 8, a vehicle suspension system (51) for providing a flexible connection between the vehicle chassis (13) and a forward axle (53) will now be described.

The vehicle chassis (13) includes two longitudinal beams (55). Each longitudinal beam (55) is stepped upwards as it passes over the forward axle (53).

The connection between the vehicle chassis (13) and the axle (53) includes two longitudinal link members (57) and two angled link members (59). The angled link members (59) are oriented in a direction that is between a longitudinal axis or direction and a transverse axis or direction of the vehicle chassis (13). It is envisaged that the angled link members (59) are ideally oriented in a direction that is between thirty and sixty degrees offset from the longitudinal axis of the vehicle chassis (13), and more preferably between forty and fifty degrees offset from the longitudinal axis of the vehicle chassis (13).

The connection between the vehicle chassis (13) and the axle (53) also includes two resilient members (61). The resilient members (61) include shock absorbers and springs to support the weight of the loaded vehicle (23).

The arrangement of the two longitudinal link members (57), the two angled link members (59) and the two resilient members (61) is designed to allow movement of the axle (53) in a substantially vertical direction only.

The longitudinal link members (57) and the angled link members (59) are connected to a lower portion of the stepped longitudinal beams (55) of the chassis (13). And the resilient members (61) are connected to an upper portion of the stepped longitudinal beams (55).

The longitudinal link members (57) are connected to a lower portion of the axle (53) and the angled link members (59) are connected to an upper portion of the axle (53). The angled link members (59) are connected to the axle at a location at or adjacent a centre section of the axle (53) and the longitudinal link members (57) are connected to the axle (53) at locations at or adjacent each end of the axle (53).

It can be seen in FIG. 8 that the connection between the longitudinal link members (57) and the longitudinal beams (57) of the chassis (13) is aligned with a lower flange (63) of the longitudinal beams (55). And the connection between the angled link members (59) and the longitudinal beams (55) is aligned with an upper flange (65) of the longitudinal beams (55).

As noted above, the aft suspension system (11) and the forward suspension system (51) are designed for use on a heavy haulage vehicle (23). Although not shown in the figures, heavy haulage vehicle (23) also includes wheels, a cab and a tip-tray. The heavy haulage vehicle (23) includes two rear axles (15) and each rear axle (15) is connected to the chassis (13) of the vehicle by a vehicle suspension system (11) as described above. The vehicle suspension system (11) of the forward of the two rear axles (15) is a mirror image of the vehicle suspension system (11) of the aft of the two rear axles (15).

The longitudinal links (17) of the forward-most rear axle (15) are connected to the rear face of the forward-most rear axle (15), and the longitudinal links (17) of the aft-most rear axle (15) are connected to the forward face of the aft-most rear axle (15). The first longitudinal link (17) of the forward-most rear axle (15) and the first longitudinal link (17) of the aft-most rear axle (15) are each connected to a first fixed strut (25) that extends downwards from one side of the chassis (13) of the vehicle (23), and the second longitudinal link (17) of the forward-most rear axle (15) and the second longitudinal link (17) of the aft-most rear axle (15) are each connected to a second fixed strut (25) that extends downwards from the opposite side of the chassis (13).

FIG. 8 shows resilient member attachment lugs (69), longitudinal member attachment lugs (71) and angled member attachment lugs (73), on a forward end of the chassis (13).

An engine (81) of the vehicle (23) is situated low and between the chassis beams (55), immediately aft of the attachment points of the forward vehicle suspension system (51). In this way the centre of gravity of the vehicle (23) is kept low, and there is a direct route for the drive train to the rear axles (15).

Variations

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the example described above, the vehicle suspension systems included metal spring style shock struts. It is envisaged that in an alternative configuration air springs could be used.

### DEFINITIONS

Throughout this specification the word “comprise” and variations of that word, such as “comprises” and “comprising”, are not intended to exclude other additives, components, integers or steps.

Advantages

Thus it can be seen that at least the preferred form of the invention provides a vehicle suspension system in which the longitudinal link members are appropriately aligned to transfer the largely longitudinal acceleration and braking forces between the axle housings and the vehicle chassis, without picking up any appreciable side loads when the vehicle is travelling over rough terrain. This minimises the need for excessively large and therefore heavy suspension components.

In addition, the configuration of the suspension system provides sufficient length for the operation of the shock struts of the resilient members as well as strong and direct attachment to the underside of the vehicle chassis allowing efficient and secure load transfer when travelling over rough terrain while carrying a heavy payload.

The combination of the low centre of gravity of the vehicle and the compact and robust suspension systems provides a multi-role haulage vehicle that can carry heavy payloads both over rough terrain and also at speed over long distances over paved surfaces.

1. A vehicle suspension system for providing a flexible connection between a vehicle chassis and at least one axle housing, the vehicle suspension system having three longitudinal link members, at least one transverse link member, and at least one resilient member situated adjacent each end of the axle housing; all of which are connected at one end to the vehicle chassis and at an opposite end to the axle housing, wherein the at least one transverse link member is configured to substantially prevent movement of the axle housing in a transverse direction, and the three longitudinal link members are each substantially aligned with the longitudinal axis of the chassis and are spaced apart to provide a three point connection between the chassis and the axle housing which is configured to keep the axle housing in a substantially transverse orientation relative to the chassis and to prevent rotation of the axle housing about the longitudinal axis of the axle housing while allowing movement of the axle housing in the vertical plane, and wherein movement of the axle housing in the vertical plane is limited by the resilient members which connect each end of the axle to the chassis.

2. A vehicle suspension system as claimed in claim 1, wherein the vehicle suspension system includes two resilient members at each end of the or each axle housing.

3. A vehicle suspension system as claimed in claim 2, wherein each of the two resilient members at each end of the or each axle housing is positioned on an opposite side of the axle housing to the other.

4. A vehicle suspension system as claimed in claim 1, wherein the connection of the resilient members to the or each axle housing is situated near or adjacent the lowest point of the or each axle housing in the vicinity of the connection.

5. A vehicle suspension system as claimed in claim 1, wherein a first of the three longitudinal links is connected to a left half of the axle housing, and a second of the three longitudinal links is connected to a right half of the axle housing.

6. A vehicle suspension system as claimed in claim 5, wherein a third of the three longitudinal links is connected to a mid section of the axle.

7. A vehicle suspension system as claimed in claim 5, wherein the first and the second longitudinal links are connected to points low on the axle housing and the third longitudinal link is connected to a point high on the axle housing.

8. A vehicle suspension system as claimed in claim 1, wherein each of the longitudinal links is substantially parallel to the others.

9. A vehicle suspension system as claimed in claim 5, wherein the first and the second longitudinal links are each connected to fixed struts which extend downwards from the main longitudinal chassis members.

10. A vehicle suspension system as claimed in claim 1, wherein the longitudinal and transverse links are connected to both the chassis and to the axle housing using pinned joints.

11. A vehicle suspension system as claimed in claim 1, wherein the resilient members include springs.

12. A vehicle suspension system as claimed in claim 1, wherein the resilient members include shock absorbers.

13. A vehicle suspension system for providing a flexible connection between a vehicle chassis and a forward axle, the chassis comprising two longitudinal beams, each longitudinal beam being stepped upwards as it passes over the axle, and the connection between the vehicle chassis and the axle comprising two longitudinal link members, two angled link members and two resilient members configured to allow movement of the axle in a substantially vertical direction only, the angled link members being oriented in a direction that is between a longitudinal direction and a transverse direction.

14. A vehicle suspension system as claimed in claim 13, wherein the angled link members are oriented in a direction that is between thirty and sixty degrees offset from the longitudinal direction.

15. A vehicle suspension system as claimed in claim 13, wherein the longitudinal link members are connected to a lower portion of the stepped longitudinal beams of the chassis.

16. A vehicle suspension system as claimed in claim 13, wherein the resilient members are connected to an upper portion of the stepped longitudinal beams of the chassis.

17. A vehicle suspension system as claimed in claim 13, wherein the longitudinal link members are connected to a lower portion of the axle.

18. A vehicle suspension system as claimed in claim 13, wherein the angled link members are connected to an upper portion of the axle.

19. A vehicle suspension system as claimed in claim 13, wherein the angled link members are connected to the axle at a location at or adjacent a centre section of the axle.

20. A vehicle incorporating at least one vehicle suspension system substantially as claimed in claim 19.
